(19) United States
(12) Patent Application Publication
(10) Pub. No.: US 2007/0019808 A1
(43) Pub. Date: Jan. 25, 2007

(54) Substrates having a position encoding pattern

(75) Inventor: Andreu Gonzalez, Sant Cugat del Valles (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/485,277

(22) Filed: Jul. 13, 2006

(30) Foreign Application Priority Data
Jul. 18, 2005 (GB) 0514587.5

(51) Int. Cl. G09C 3/08

(52) U.S. Cl. 380/51

(57) ABSTRACT

A substrate carrying a machine-readable pattern, the pattern comprising a plurality of printed shapes, local portions of the pattern uniquely encoding respective locations of the substrate, the substrate further carrying a human-recognisable printed image, wherein the human-recognisable image is masked at locations of the printed shapes of the machine-readable pattern, thereby preventing the machine-readable pattern from being obscured by the human-recognisable printed image.

This application claims priority from Great Britain patent application 0514587.5, filed on Jul. 18, 2005. The entire content of the aforementioned application is incorporated herein by reference.

### FIELD OF THE INVENTION

This invention relates to substrates, such as paper, having a machine-readable position encoding pattern recorded thereon. The substrates may be used with a so-called “digital pen” adapted to decode local portions of the pattern. This technology is generally known as “digital pen and paper” technology.

More particularly, this invention relates to substrates of the above type also having a human-readable image recorded thereon. The human readable image may, for example, comprise text and/or graphics.

### BACKGROUND OF THE INVENTION

The paper used in digital pen and paper technology carries a position encoding background pattern. For example, the pattern may comprise non-uniform pattern of dots. The local dot pattern at all locations of the background pattern is unique and identifies the location. The number of different possible local dot patterns is preferably sufficiently large that a large number of different pages can be provided with different background patterns, with different local dot patterns at all locations for all pages. Thus, any local dot pattern can identify not only a position on the page, but also a page of a multiple page document.

To use a digital pen and paper system, a user has an electronic pen for writing over the background pattern. This pen is both a reading and a writing device, and allows the user to write over the paper where he/she chooses, but also identifies the locations at which markings are written by reading the local dot pattern. The pen typically comprises a digital camera, an image processing unit and a wireless transceiver, and is battery operated. The pen also writes in ink, so that from the user's point of view, the pen has normal functionality.

There are many different possible encoding schemes which can be used for the background pattern. However, the pattern typically comprises a large number of small dots printed on the paper in an asymmetrical pattern. By way of example, the dots in the pattern may have a nominal spacing of around 0.3 mm. The pattern is arranged such that the dots are displaced from a strict grid arrangement, and the local dot pattern detected by the camera can then be used to determine the pen position.

There are many possible applications for digital pen and paper technology. Essentially, it provides a means of digitising handwritten text and drawings, including location information, at the same time that the information is being written on the paper. This provides immediate digital information for further handling and processing.

In many applications, it is necessary to provide an overlying image on the paper. For example, a form can be provided by printing a paper substrate with an overlying image comprising text and graphics. The overlying image provides spaces in the paper form for a user to insert handwritten text. In these applications, the overlying image can obscure the background pattern and thereby degrade the ability of a reading device in a digital pen to correctly detect and decode all of the local dot patterns on the paper.

It is known to provide the overlying image as a feint watermark in order to maintain the visibility of the background pattern, thereby improving the performance of the reading device. However, there is then a trade off between performance of the reading device and visual quality of the overlying image.

In full colour applications, it is also known to reserve a particular colour for the background pattern. Since different colours have different spectral properties, the background pattern can then be distinguished from the overlying image. However, the different colour inks or toners that are used to print the background pattern and the overlying image can interact to affect the printed quality of the background pattern. Known issues include charge interactions between toner particles and bleeding of liquid inks.

### SUMMARY OF THE INVENTION

According to an aspect of the invention, there is provided a substrate carrying a machine-readable pattern, the pattern comprising a plurality of printed shapes, local portions of the pattern uniquely encoding respective locations of the substrate, the substrate further carrying a human-recognisable printed image, wherein the human-recognisable image is masked at locations of the printed shapes of the machine-readable pattern, thereby preventing the machine-readable pattern from being obscured by the human-recognisable printed image.

The invention thus provides a substrate carrying both a machine-readable pattern and a human-recognisable printed image. In locations covered by both the pattern and the printed image, the printed image is masked, or “protected”. In this way, clear visibility of the pattern is ensured, regardless of the nature of the printed image.

The masked portions of the human-recognisable printed image may be larger than the respective printed shapes of the machine-readable pattern, thereby providing a “protected” band around the shapes of the machine-readable pattern. This helps in distinguishing the printed shapes of the machine-readable pattern from the human-recognisable printed image. The depth of the protected band may be sufficient to enable the machine-readable pattern to be read, while at the same time not having a significant effect on the visual quality of the human-recognisable printed image.

In a particular embodiment, the printed shapes of the machine-readable pattern and the masked portions of the human-recognisable printed image are both circular in shape. In this case, they may also be concentric.

The printed shapes of the machine-readable pattern and the human-recognisable printed image may be monochrome. For example, the machine-readable pattern may be black and the masked portions of the human-recognisable printed image are then white, or vice versa.

The printed shapes of the machine-readable pattern and/or the human-recognisable printed image may alternatively comprise more than one colour. In this case, all colours of the human-recognisable printed image may be masked at the locations of the printed shapes of the machine-readable pattern. In this way interactions between the toner or ink of the machine-readable pattern and the human-recognisable printed image are avoided.

The human-recognisable printed image may comprise text and/or graphics. Graphics may include photographs represented as bitmap images. For example, the human-recognisable printed image may be a representation of a form, and the form may provide various spaces for completion by a user.

According to another aspect of the invention, there is provided a system for decoding position on a substrate, the system comprising: the substrate described above; a reading device for reading local portions of the pattern; and a means for decoding the local portions of the pattern to identify respective locations of the substrate. The reading device and the means for decoding may be integrated into a pen-shaped enclosure. In a particular embodiment, the system comprises a so-called digital pen.

According to another aspect of the invention, there is provided a method for processing data for printing on a substrate, the method comprising: obtaining a machine-readable pattern and a human-recognisable image, the machine-readable pattern comprising a plurality of shapes, local portions of the pattern uniquely encoding respective spatial locations; generating a mask image for the human-recognisable image, the mask image being based on the machine-readable pattern; applying the mask image to the human-recognisable image to generate a masked human-recognisable image; and combining the machine-readable pattern and the masked human-recognisable image to generate a composite image for printing, wherein the masked human-recognisable image is masked at spatial locations of the shapes of the machine-readable pattern, thereby preventing the machine-readable pattern from being obscured by the human-recognisable image.

This aspect provides a method of processing data for printing as the substrate described above. The method may further comprise printing the composite image on the substrate.

In a particular embodiment, the step of generating the mask image comprises: determining shapes of the machine-readable pattern that would otherwise be obscured by the human-recognisable image; and generating the mask image for the human-recognisable image, the mask image being based on shapes of the machine-readable pattern determined as the shapes that would be obscured by the human-recognisable image. In this way, only portions of the human-recognisable image that would obscure the machine-readable pattern are masked.

The step of determining shapes of the machine-readable pattern may include determining shapes of the machine-readable pattern that have a surrounding band of area that would be obscured by the human-recognisable image.

The shapes of the machine-readable pattern and the human-recognisable image may be monochrome. Alternatively, the shapes of the machine-readable pattern and/or the human-recognisable image may comprise more than one colour. In this case, the mask image may be used to mask all colours of the human-recognisable image.

The method may be carried out on different types of data, at different stages in a printing process. For example, the mask image may be used to mask the human-recognisable image represented in an RGB colourspace, during parsing of the image. The human-recognisable image that has been parsed may then be converted from the RGB colourspace to a CMYK colourspace for printing. Alternatively, the mask image may be used to mask the human-recognisable image after parsing, the image being already represented in a CMYK colourspace.

According to another aspect of the invention, there is provided a computer program comprising computer program code means adapted to perform all of the steps of the above method when said program is run on a computer.

### BRIEF DESCRIPTION OF THE DRAWINGS

Examples of the invention will now be described with reference to the accompanying drawings, in which:

FIG. 1 shows a paper substrate used in digital pen and paper technology;

FIG. 2 shows an enlarged part of the pattern of the substrate of FIG. 1;

FIG. 3 shows a reading device used in digital pen and paper technology;

FIG. 4 is used to explain one way in which a dot pattern can encode position information;

FIG. 5 shows a paper substrate according to the invention;

FIG. 6 is a photograph of the substrate shown in FIG. 5;

FIGS. 7a, 7b and 7c are used to explain a method of processing data for printing on a substrate according to the invention; and

FIGS. 8a and 8b are used to explain how a method of processing data according to the invention can be implemented at different stages in a printing process.

### DETAILED DESCRIPTION

This invention relates to a substrate carrying a machine-readable pattern superimposed with a human-recognisable printed image. The machine-readable pattern is typically provided for use with a technology known as digital pen and paper technology.

Before describing the invention in detail, an overview will be given of the digital pen and paper technology.

The paper used in digital pen and paper technology typically carries a non-uniform background pattern of circular dots, although other shapes are possible. The pattern of dots at any location encodes location information for the location on the page. An overlying image, for example a document image containing text and graphics, is typically also provided. The local dot pattern on all locations of the background pattern is unique and identifies the location. The number of different possible local dot patterns is preferably sufficiently large that a large number of different pages can be provided with different background patterns, with different local dot patterns at all locations for all pages. Thus, any local dot pattern can identify not only a position on the page, but can also identify a page of a multiple page document or one document from several documents.

There are many known uses for digital pen and paper technology. Conventionally, it has been used as a means of digitising handwritten text and drawings at the same time that the information is being written on the physical paper. This provides immediate digital information for further handling and processing.

For example, the technology has been used for creating a data file providing the information which has been handwritten on a paper form. An example of this known use of the technology will first be described, to explain the technology.

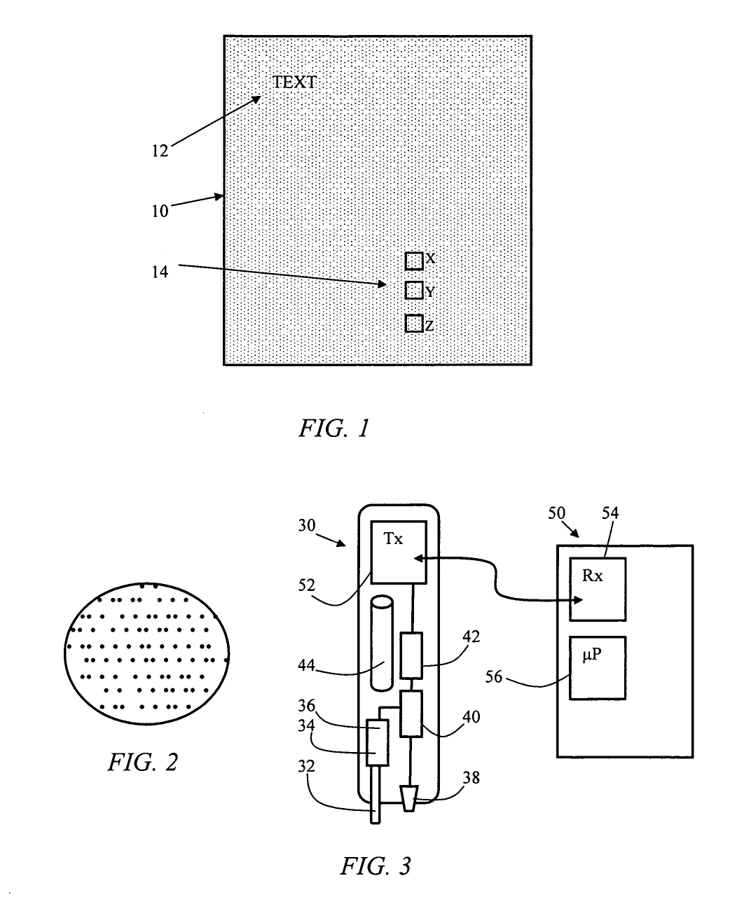

FIG. 1 shows in simplified manner a form which may be printed for use with a digital pen of a system using digital pen and paper technology.

The form 10 has text and images 12 and spaces 14 where the user is required to write to complete the form. The form is provided on a paper substrate carrying the non-uniform background pattern of dots.

To use this type of system, the user has an electronic pen for writing over the form. This pen is both a reading and a writing device, and allows the user to write over the form where he/she chooses but also identifies the locations at which markings are written by reading the local background pattern. The pen stores in a memory the dot patterns at the locations of all written markings.

This provides the user with an easy interface, where the user is simply required to write over a form in conventional manner. The system recognizes the location of marks made on the form, and can additionally perform character recognition for text entries.

The technology for defining the background dot pattern and for the electronic pen is already available. For this reason, only a brief discussion of the technology will now be given.

FIG. 2 shows an enlarged part of the dot pattern. The pattern is slightly displaced from an orthogonal grid. In one example, an area of 6×6 dots gives a unique position. With each dot in one of four possible positions, this allows 4³⁶ (=2⁷²) different locations to be encoded. With dot spacing of 0.3 mm, a 6×6 dot area covers less than 2 mm×2 mm, and the overlap of 6×6 dot areas enables adjacent identifiable locations to be spaced only 0.3 mm apart.

FIG. 3 shows the digital pen and a computer with which it communicates.

The pen 30 comprises a nib 32 coupled to an ink cartridge 34 and pressure sensor 36 for detecting when markings are being written. An image sensor camera 38 detects the local dot pattern. The pressure sensor and camera supply data to a processor 40. When information is being written, the pen detects this using the pressure sensor and at this time the image sensor, for example camera, detects the local dot pattern under the control of the processor 40.

The pen has a memory 42 for storing the camera information, either as recognised dot patterns or as the corresponding locations, of all written markings. The pen does not require significant processing power, but simply computes the location of the pen within the page by collecting and storing the patterns on the fly. The pen is stand alone and is powered by battery 44.

The information stored in the electronic pen can be downloaded into a central computer 50 having a receiver 54 and processor 56, with which the pen communicates using a transmitter 52.

In one known encoding scheme, the dot may be displaced by a fixed amount in any one of the four axial directions (i.e. up, down, left or right). Each dot thus has four possible positions. A sub-array of dots then encodes one location. This sub-array may have a variety of sizes, depending on the resolution required and the number of locations to be encoded.

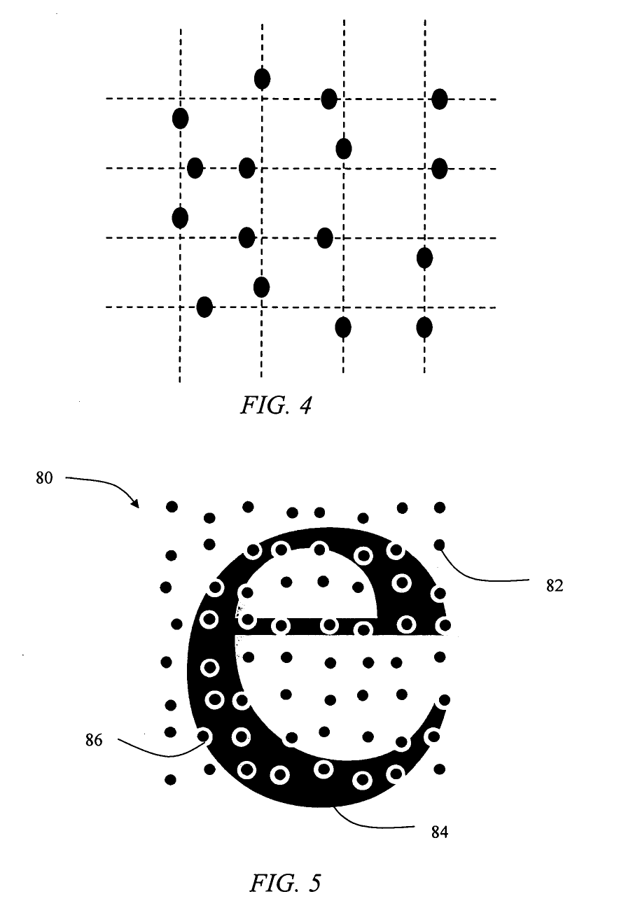

FIG. 4 shows an example of this encoding scheme, in which each dot is displaced by a fixed amount from the reference grid (in dashed lines) in one of the four axial directions. When writing with the digital pen, snapshots of the patterns are captured. Each snapshot contains enough information to calculate the exact location of the pen within the page.

This invention specifically provides a substrate carrying a machine-readable pattern superimposed with a human-recognisable printed image, and a method for processing data for printing the substrate. According to the invention, the substrate is printed so that the entire background pattern is visible, this being achieved by selective masking of the human-recognisable image.

FIG. 5 is a diagram of an enlarged portion of a printed paper substrate 80 according to the invention. The substrate 80 is printed, for example using a laser printer, but any printing technology capable of providing sufficient resolution is suitable.

The substrate 80 carries a machine-readable background pattern 82. The background pattern 82 is printed on the substrate 80 in black ink. The surface of the substrate 80 is white. The background pattern 82 comprises a non-uniform pattern of circular dots, of the type described with reference to FIG. 4. As described above, local portions of the background pattern 82 uniquely encode respective locations of the substrate 80.

The substrate 80 also carries a human-recognisable printed image 84. The human-recognisable image 84 is a passage of text, only one character of which is shown. The human-recognisable image 84 is printed in black ink over the top of the background pattern 82.

The human-recognisable image 84 is masked at locations 86 where it overlies the dots that make up the background pattern 82. In other words, the body and outline of the human-recognisable image 84 is such that they do not obscure the individual dots of the background pattern 82, or a small band of area surrounding the dots. The human-recognisable image 84 does, however, overlie the spaces between the dots of the background pattern 82.

The masking of the human-recognisable image 84 is based on the background pattern 82. In particular, dots of the background pattern 82 provide the basis for masked portions, the masked portions being circular in shape and concentric with the dots. Each masked portion is slightly larger than the respective dot, so that a small band of area around the dot, as well as the dot itself, is not obscured by the human-recognisable image 84.

The dots of the background pattern 82 only cover a small proportion of the surface of the substrate 80, for example five percent of the surface area. The dots of the background pattern 82 are also well distributed, and small in size in comparison to the human-recognisable image 84. Thus, the masking of the human-recognisable image 84 in this way does not significantly affect its overall visual character.

By masking the human-recognisable image 84, as described above, the background pattern 82 is effectively “protected” from being obscured. The background pattern 82 may then easily be detected at all locations using a reading device. The masking effectively aids discrimination between dots of the background pattern 82 and the human-recognisable image.

In contrast, without any masking of a human-recognisable image as described above, a background pattern printed on a substrate cannot easily be detected at all locations using a reading device as it is obscured.

By improving the detection of the background pattern, the decoding of handwritten data by the digital pen described above with reference to FIG. 3 is improved.

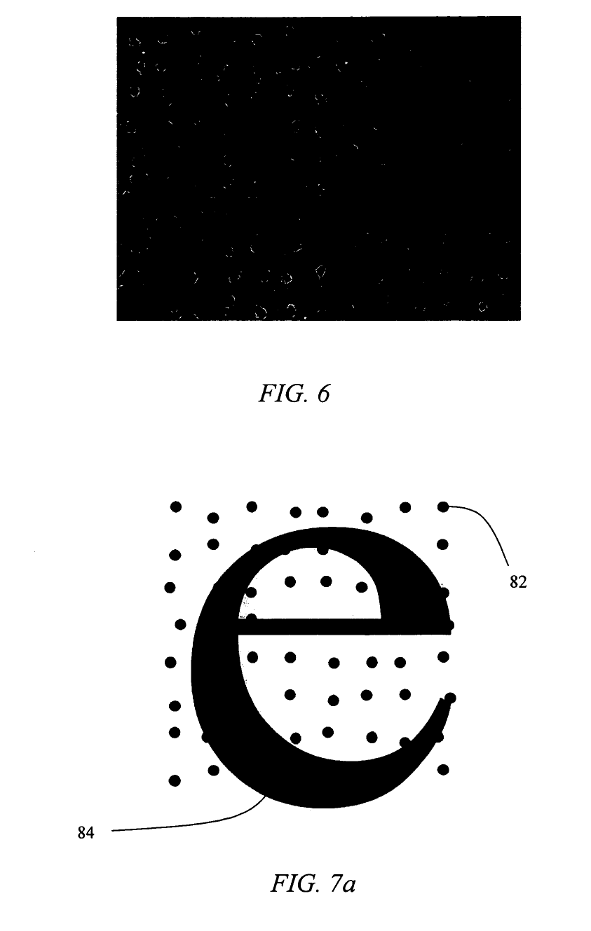

FIG. 6 is a photograph of the paper substrate shown in FIG. 5. The paper substrate shown in the Figure has been tested using a digital pen, and it was found that the position decoding performance was improved compared to use with a similar substrate having no masking of the human-recognisable image. It can be seen from the Figure that the visual character of the human-recognisable image is not significantly affected by the masking.

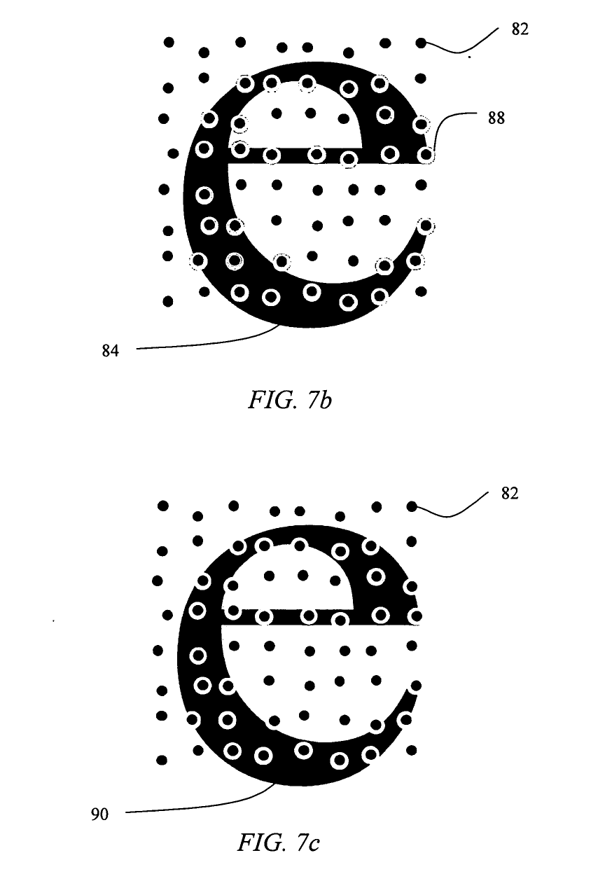

FIGS. 7a, 7b and 7c are used to explain a method of processing data for printing on a substrate according to the invention.

The first step in the data processing method is to obtain a machine-readable pattern 82 and a human-recognisable image 84. The machine-readable pattern 82 comprises a non-uniform position encoding pattern of circular dots. The human-recognisable image comprises the character “e”. Both the machine-readable pattern 82 and the human-recognisable image 84 are monochromatic (black and white).

The next step in the method is to overlay the machine-readable pattern 82 and the human-recognisable image 84 as they are intended to appear on a printed substrate, as shown in FIG. 7a.

Next, the particular dots of the machine-readable pattern 82 that are directly underneath the overlaid human-recognisable image 84 are identified. Dots of the pattern 82 that are very close to the image 84 are also identified in this step.

The next step in the method is that a mask image is generated for the human-recognisable image 84, as shown in FIG. 7b. The mask image is based on the machine-readable pattern 82. In particular, the mask image comprises a plurality of circles 88. A circle 88 is provided for each dot of the machine-readable pattern 82 identified as being underneath or close (sufficiently close for the circle 88 to overlap at least partially) to the human-recognisable image 84. The circles 88 are concentric with and slightly larger than the respective dots of the machine-readable pattern 82.

Next, the mask image is applied to the human-recognisable image 84 to generate a masked version 90 of the human-recognisable image. In this step, the circles of the mask image are effectively subtracted from the human-recognisable image 84. The masked version 90 of the human-recognisable image corresponds to the unmasked version 84, except that there are “holes” in the masked version corresponding to the locations of the dots of the machine-readable pattern 82.

Finally, the masked version 90 of the human-recognisable image is combined with the machine-readable pattern 82, as shown in FIG. 7c. As can be seen, the masking of the human-recognisable image 84 prevents any of the dots of the machine-readable pattern 82 from being obscured.

In an additional step, the combined data may be printed on a paper substrate for use with a digital pen. The decoding performance of the digital pen when used with the substrate printed according to the above method is improved compared to a substrate carrying an unmasked version 84 of the human-recognisable image.

The method of the invention described above is typically implemented by a computer system running under the control of a computer program. The computer program is provided on a computable readable medium such as a CD-ROM or a DVD. The computer system typically comprises a processing unit, a display unit, a storage unit, and a keyboard and mouse for inputting user commands. A printer is typically connected to the computer system for printing the substrate.

In the example of the invention described above, the machine-readable pattern and the human-recognisable image are monochrome. The invention is equally applicable to substrates printed with a plurality of colours, even where the machine-readable pattern is printed in a different colour to that of the human-recognisable image.

In this case, the human-recognisable image is masked using a mask image prepared as described above for the monochromatic example. In the masking step, all colours of the human-recognisable image are masked. In this way, interaction effects between different colours of the machine-readable pattern and the human recognisable image are avoided, thereby providing a high quality printed background pattern.

The method of processing data for printing on a substrate, as described above, can be implemented at various different stages in a printing process, two examples of which will be described. These examples relate to substrates printed in full colour, but the same principles apply for a monochromatic example.

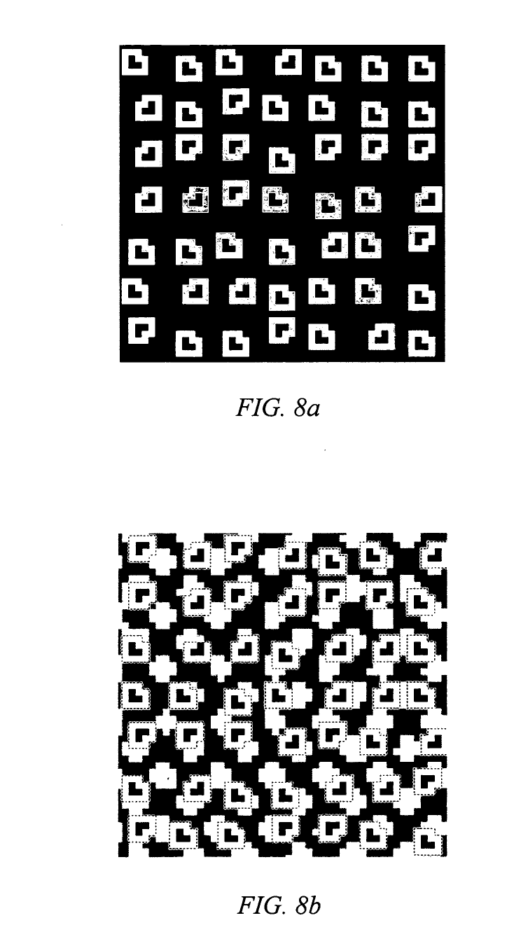

The method may be implemented in the early stages of the operation of a printer driver. In this case, the mask image may be applied to the human recognisable image during parsing of an image in the RGB (red, green, blue) colourspace, which is essentially the first main process performed by the printer driver. The printer driver may, for example send an ROP (raster operation) macro instructing the parser to perform a logical operation on the machine-recognisable pattern, the mask image and a raster representing the human-recognisable image. An example of the final resulting 24-bit image is shown in FIG. 8a. As can be seen, in this case, the machine-readable pattern comprises a plurality of L-shapes.

Implementing the method in this way requires relatively low levels of data processing, and a common approach may be used regardless of the particular printer characteristics. However, implementing the method in this way also means that the method is not optimised for the particular printer, and the masking is prone to distortion during conversion from the RGB colourspace to a CMYK (cyan, magenta, yellow, black) colourspace.

Alternatively, the method may be implemented later in the printing process, after the human-recognisable image in the RGB colourspace has been converted into the CMYK colourspace and post-processed. In this case, low level commands in ASIC may be used to apply the mask by individual colour plane. An example of the final resulting Y (yellow) plane halftone image is shown in FIG. 8b. The dashed lines in this example represent the masked areas of the human-recognisable image.

Implementing the method in this way involves more processing and is printer specific, but it allows greater control of the masking process as it is implemented after colourspace conversion.

A specific example of the invention has been described above. Various modifications within the scope of the invention will be apparent to persons skilled in the art.

For example, in the above described full colour application of the invention, all colours of the human-recognisable image are masked. However, in particular embodiments, only a limited number of the colours of the human-recognisable image may be masked.

In an embodiment of the invention, the masked portions may be filled with a color in order to improve the effect for a human eye. For instance, for the case of a black pattern and CMYK contents on top, the masked portion may be filled in Cyan, which is at least more similar to black than a blank area, but which remains for example invisible in the IR range, so that a pen modified to receive in the IR range is not disturbed.

The invention is described in relation to digital pen and paper technology. However, it is applicable to any substrate carrying a machine-readable pattern and a human-recognisable image as recited in the claims.

We claim:

1. A substrate carrying a machine-readable pattern, the pattern comprising a plurality of printed shapes, local portions of the pattern uniquely encoding respective locations of the substrate, the substrate further carrying a human-recognisable printed image, wherein the human-recognisable image is masked at locations of the printed shapes of the machine-readable pattern, thereby preventing the machine-readable pattern from being obscured by the human-recognisable printed image.

2. A substrate according to claim 1, wherein the masked portions of the human-recognisable printed image are larger than the printed shapes of the machine-readable pattern.

3. A substrate according to claim 1, wherein the printed shapes of the machine-readable pattern and the masked portions of the human-recognisable printed image are circular.

4. A substrate according to claim 3, wherein the printed shapes of the machine-readable pattern and the masked portions of the human-recognisable printed image are concentric.

5. A substrate according claim 1, wherein the printed shapes of the machine-readable pattern and the human-recognisable printed image are monochromatic.

6. A substrate according to claim 1, wherein the printed shapes of the machine-readable pattern and/or the human-recognisable printed image comprise more than one colour, and wherein all colours of the human-recognisable printed image are masked at the locations of the printed shapes of the machine-readable pattern.

7. A substrate according to claim 1, wherein the human-recognisable printed image comprises text and/or graphics.

8. A system for decoding position on a substrate, the system comprising:
a substrate according to claim 1;
a reading device for reading local portions of the pattern; and
a means for decoding the local portions of the pattern to identify respective locations of the substrate.

9. A method for processing data for printing on a substrate, the method comprising:
obtaining a machine-readable pattern and a human-recognisable image, the machine-readable pattern comprising a plurality of shapes, local portions of the pattern uniquely encoding respective spatial locations;
generating a mask image for the human-recognisable image, the mask image being based on the machine-readable pattern;
applying the mask image to the human-recognisable image to generate a masked human-recognisable image; and
combining the machine-readable pattern and the masked human-recognisable image to generate a composite image for printing, wherein the masked human-recognisable image is masked at spatial locations of the shapes of the machine-readable pattern, thereby preventing the machine-readable pattern from being obscured by the human-recognisable image.

10. A method according to claim 9, further comprising printing the composite image on the substrate.

11. A method according to claim 9, wherein the step of generating the mask image comprises:
determining shapes of the machine-readable pattern that would be obscured by the human-recognisable image; and
generating the mask image for the human-recognisable image, the mask image being based on shapes of the machine-readable pattern determined as the shapes that would be obscured by the human-recognisable image.

12. A method according to claim 11, wherein the step of determining shapes of the machine-readable pattern includes determining shapes of the machine-readable pattern having a surrounding band that would be obscured by the human-recognisable image.

13. A method according to claim 9, wherein the shapes of the machine-readable pattern and the human-recognisable image are monochromatic.

14. A method according to claim 9, wherein the shapes of the machine-readable pattern and/or the human-recognisable image comprise more than one colour, and wherein the mask image is used to mask all colours of the human-recognisable image.

15. A method according to claim 14, wherein the mask image is used to mask the human-recognisable image represented in an RGB colourspace.

16. A method according to claim 15, further comprising the step of converting the human-recognisable image represented in the RGB colourspace to the human-recognisable image represented in a CMYK colourspace.

17. A method according to claim 14, wherein the mask image is used to mask the human-recognisable image represented in a CMYK colourspace.

18. A computer program comprising computer program code means adapted to perform a method for processing data for printing on a substrate when said program is run on a computer, the method comprising:
obtaining a machine-readable pattern and a human-recognisable image, the machine-readable pattern comprising a plurality of shapes, local portions of the pattern uniquely encoding respective spatial locations;
generating a mask image for the human-recognisable image, the mask image being based on the machine-readable pattern;
applying the mask image to the human-recognisable image to generate a masked human-recognisable image; and
combining the machine-readable pattern and the masked human-recognisable image to generate a composite image for printing, wherein the masked human-recognisable image is masked at spatial locations of the shapes of the machine-readable pattern, thereby preventing the machine-readable pattern from being obscured by the human-recognisable image.

19. The computer program of claim 18 embodied on a computer readable medium.
